(19) United States
(12) Patent Application Publication
(10) Pub. No.: US 2015/0132071 A1
(43) Pub. Date: May 14, 2015

(54) Device for Explosion Decoupling of Two System Parts

(71) Applicant: Keller Lufttechnik GmbH + Co. KG, Kirchheim/Teck (DE)

(72) Inventors: Josse Wolf, Nurnberg (DE); Morris Koch, Kirchheim/Teck (DE); Waldemar Gillung, Goppingen (DE)

(21) Appl. No.: 14/400,558

(22) PCT Filed: Apr. 12, 2013
(86) PCT No.: PCT/EP2013/057650

§ 371 Date: Nov. 12, 2014

(30) Foreign Application Priority Data
May 25, 2012 (DE) 10 2012 104 526.7

(51) Int. Cl. B65G 53/58; B65G 53/04

(52) U.S. Cl. CPC B65G 53/58; B65G 53/04
USPC 406/12

(57) ABSTRACT

The invention relates to a device for explosion decoupling of two system parts. Dust that is capable of exploding can be fed in the process from a first system part in an air flow via a pipeline (3) into a container of the second system part. A non-return flap (8) is provided in a pipe element (9) integrated into the pipeline (3). The non-return flap (8) is opened by the air flow and closed when there is an explosion in the container because of the explosion pressure that arises. The non-return flap (8) makes contact with a limit stop (11) in the pipe element (9) when it is closed. A locking device (12) is provided on the outside of the pipe element (9) by means of which the non-return flap (8) is secured in the closed position.

### CROSS-REFERENCE TO RELATED APPLICATIONS

This application is the U.S. national stage of International Application No. PCT/EP2013/057650 filed on Apr. 12, 2013, and claims the benefit thereof. The international application claims the benefit under 35 USC 119 of German Application No. DE 102012104526.7 filed on May 25, 2012; all applications are incorporated by reference herein in their entirety.

### BACKGROUND OF THE INVENTION

The invention relates to a device in accordance with the preamble of claim 1.

A device of that type is known from DE 10 2007 010 060 B3. This device serves to provide explosion decoupling of two system parts. Dust that is capable of exploding can be fed from a first system part in an air flow via a pipeline into a container of the second system part. A non-return flap that is opened by the air flow and closed when there is an explosion in the container because of the explosion pressure that arises is provided in a pipe element integrated into the pipeline. The non-return flap makes contact with a limit stop in the pipe element when it is closed. A position sensor, by means of which the closing position of the non-return flap can be checked because deposits on the non-return flap or on the limit stop of the pipe element can be detected by it, is allocated as a monitoring unit to monitor the non-return flap or to ensure its operation.

The non-return flap is located in general in a pipe element that can be integrated into the respective pipeline that connects the two system parts to be decoupled. One end of the non-return flap is mounted in a hinged fashion on the inner wall of the pipe element here, so it can be moved between an open position and a closed position. The non-return flap makes contact with a limit stop in the pipe element in the closed position and consequently forms a tight seal of the pipe element. The non-return flap is mounted in such a way here that it is in its closed position because of its own weight. The non-return flap is then automatically opened by the air flow from the first system part to the second system part, so the air flow can stream through the pipe element into the second system part. If an explosion takes place in the second system part, the non-return flap is closed by the explosion pressure.

Efficient explosion protection is obtained with the non-return flap designed in this way, to the effect that an explosion that occurs will be kept local to the extent possible, meaning an uncontrolled spread of the explosion is prevented.

Systems with separators are typical application examples. Dust that is capable of exploding has to be taken from a collection point in an air flow there and then fed into a separator via a pipeline so that the dust can be removed from the air mixture at that point.

The non-return flap has to tightly close when there is an explosion to be reliably capable of fulfilling its explosion-protection function.

In the device of DE 10 2007 010 060 B3, detection is done for this with a deposit sensor as to whether the non-return flap is still firmly in its closing position on the pipe element or whether there are gaps between the non-return flap and the pipe element because of deposits. If that is the case, a corresponding warning message is generated.

A potential for danger arising from deposits of that type will therefore, in fact, be promptly recognized.

There is a further, even more serious source of danger, however, in that the non-return flap will slam against the pipe element at a high rate of speed because of explosion pressure that is wavelike, in particular, when an explosion occurs and then bounce back off it again so that explosion decoupling is no longer achieved. The explosion can then spread further through the pipe element in an out-of-control way.

### SUMMARY OF THE INVENTION

The invention relates to a device for explosion decoupling of two system parts. Dust that is capable of exploding can be fed in the process from a first system part in an air flow via a pipeline (3) into a container of the second system part. A non-return flap (8) is provided in a pipe element (9) integrated into the pipeline (3). The non-return flap (8) is opened by the air flow and closed when there is an explosion in the container because of the explosion pressure that arises. The non-return flap (8) makes contact with a limit stop (11) in the pipe element (9) when it is closed. A locking device (12) is provided on the outside of the pipe element (9) by means of which the non-return flap (8) is secured in the closed position.

### DETAILED DESCRIPTION

The invention is based on the problem of improving a device of the type mentioned at the outset with regard to its explosion functionality.

The elements of claim 1 are specified to solve this problem. Advantageous embodiments and useful design developments of the invention are described in the sub-claims.

The invention relates to a device for explosion decoupling of two system parts. Dust that is capable of exploding can be fed in the process from a first system part in an air flow via a pipeline into a container of the second system part. A non-return flap is provided in a pipe element integrated into the pipeline. The non-return flap is opened by the air flow and closed when there is an explosion in the container because of the explosion pressure that arises. The non-return flap makes contact with a limit stop in the pipe element when it is closed. A locking device is provided on the outside of the pipe element by means of which the non-return flap is secured in the closed position.

Significantly improved explosion protection is achieved in the device as per the invention by preventing, via the locking device, a backswing of the non-return flap from the pipe element when the non-return flap moves into its closed position on the pipe element during an explosion. Thus, the locking device is designed in such a way that the non-return flap quickly moves into its closed position on the pipe element due to the explosion pressure in the case of an explosion, so the non-return flap tightly closes the pipe element. At the same time, however, the locking device prevents a backswing of the non-return flap from the pipe element, so it is ensured that the non-return flap will tightly close the pipe element continuously and without interruption and thus bring about uninterrupted explosion decoupling of the two system parts.

The requirements of the latest safety standards can consequently be completely fulfilled with the device as per the invention.

A further important advantage of the invention is that the locking device is arranged outside of the pipe element and therefore outside of the area endangered by an explosion. Reliable operation of the locking device is also specifically ensured in the case of an explosion because of that. Moreover, the locking device is arranged so as to have protection against soiling; it is especially advantageous that the locking device is arranged in a separate housing on the outside of the pipe element for this.

It is especially advantageous that the locking device has a locking element coupled to the non-return flap that is held in place with a locking bolt in a locked position when the non-return flap is in the closed position.

In so doing, the non-return flap is mounted in a swiveling fashion on a shaft. One end of the shaft is brought out through the pipe element. The locking element is fastened to that end of the shaft.

An especially simple, robust and operationally reliable structure of the locking device is obtained with that. An especially simple linkage of the non-return flap to the locking device is obtained because the shaft is brought out through the pipe element and the locking element is fastened to the end of the shaft lying outside of the pipe element.

The locking bolt is held in the locked position with a restoring force in accordance with an advantageous embodiment. The locking element is held in place because of that when the non-return flap is in the closed position; the restoring force is advantageously generated by a spring.

A backswing of the non-return flap from the pipe element is prevented in an easy way in terms of construction with the restoring force that is generated in that fashion.

It is especially advantageous when the locking element constitutes a cam. The design of the locking element in the form of a cam is coordinated with the locking bolt loading with the restoring force in such a way that the cam is moved over the locking bolt via the acting explosion pressure in the case of an explosion. This is done by having the locking bolt move into its end position against the restoring force as soon as the cam has passed the locking bolt, and the non-return flap is therefore in the closed position; the locking bolt is moved into its locked position via the restoring force and the cam is blocked. The cam can no longer move against the locking bolt, and the non-return flap remains secured in its closed position.

In accordance with an advantageous embodiment of the invention, an actuation element is provided that is designed to move the locking bolt against the restoring force and out of the locked position into an unlocked position. The locking bolt releases the locking element in the unlocked position, so it can be moved out of the end position.

The actuation element advantageously has an electromagnet.

Alternatively, a hydraulic or pneumatic actuation element is provided.

The actuation element consequently constitutes an automatic unit with which the non-return flap can be released from the closed position again, especially after an explosion has occurred. A complicated manual release of the non-return flap is consequently not required.

The device for explosion decoupling as per the invention can be used in various systems in which organic or inorganic, explosive dust types accumulate, for instance in mills, fluidized bed granulators, mixers or separators.

### BRIEF DESCRIPTION OF THE DRAWINGS

The invention will be explained with the aid of the drawings below. The following are shown in the figures:

FIG. 1: Example of a system with a device for explosion decoupling of system parts.

FIG. 2: Pipe element with a non-return flap in its opened position as a component of the device in accordance with FIG. 1.

FIG. 3: Pipe element in accordance with FIG. 2 with the non-return flap in its closed position.

FIG. 4: Perspective view of the pipe element with a locking device for the non-return flap.

FIG. 5: Side view of the arrangement in accordance with FIG. 4.

FIG. 6 a)-d): Different movement phases of the locking element and the locking bolt of the locking device during movement of the non-return flap in the direction of its closed position.

### DETAILED DESCRIPTION OF THE PREFERRED EMBODIMENTS

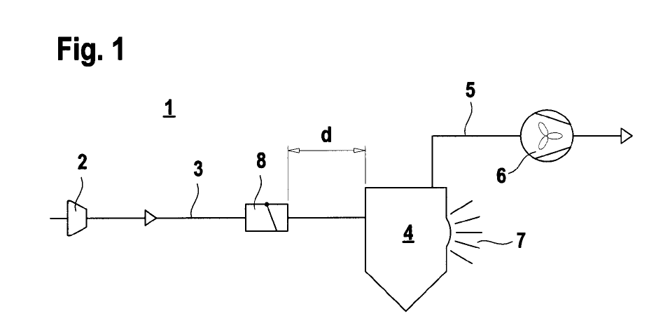

FIG. 1 shows a dust removal system as an example of a system 1 in which dust capable of an explosion arises. Dust capable of an explosion is understood to mean general dust types that could form an explosive atmosphere in gases. Dust removal systems of that type can be used, as an example, in systems in which explosive dust arises from the grinding of components made of plastic or the lacquering of parts. The explosive inorganic or organic dust is carried away from a collection point 2 in an air flow and fed via a pipeline 3 into a separator 4, a dry separator in this case. The dust is separated from the air flow in the separator 4. The cleaned exhaust air is carried off from the separator 4 through an outlet line 5 with a fan 6.

An explosion pressure relief unit 7 that is an explosion venting area in this case is provided in the separator 4 as a device for explosion protection. In the case of an explosion in the separator 4, the explosion venting area opens; critical excess pressures in the separator 4 can be avoided because of that.

A non-return flap 8 that is located in the pipeline 3 at a specified mounting distance d to the separator 4 is provided as a further device for explosion protection. This non-return flap 8 constitutes a device for explosion decoupling of the collection point 2, as the first system part, from the separator 4, as the second system part.

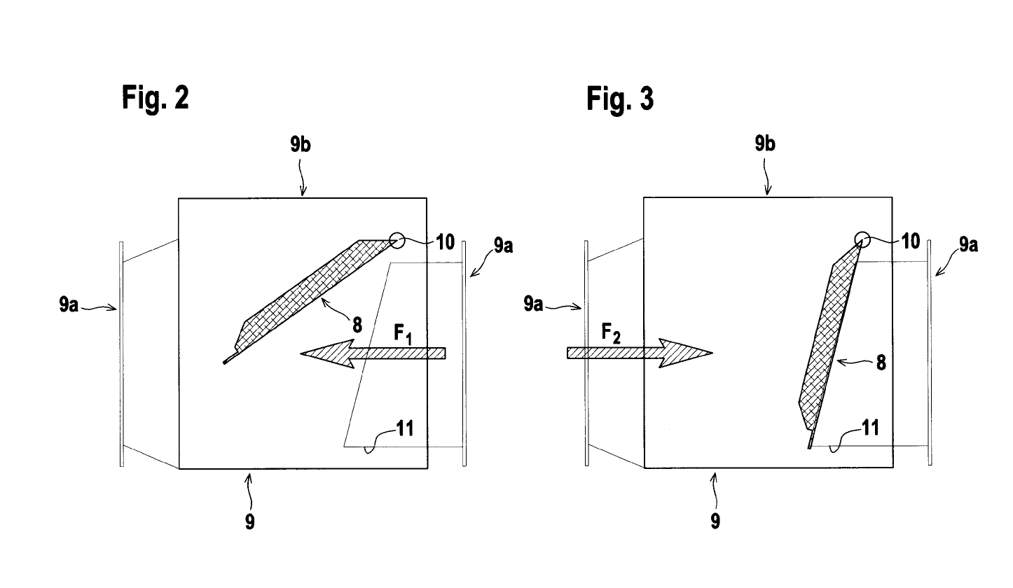

The structure of the non-return flap 8 and its manner of operator can be seen in FIGS. 2 and 3. The non-return flap 8 is integrated into a pipe element 9. The non-return flap 8 is integrated into a pipe element 9. The non-return flap 8 is preferably made of steel.

The pipe element 9 has a flow-through opening 9a going through it in an axial direction that is adapted to the cross-section of the pipeline 3. The pipe element 9 that is designed in this way can consequently be integrated into the pipeline 3 so that the air flow can go through the pipeline 3 and the flow-through opening 9a of the pipe element 9.

The non-return flap 8 is mounted in a swiveling fashion on a shaft 10.

Because of the swivel-mounting of the non-return flap 8 on the pipe element 9, it can be moved between an opened position and a closed position. FIG. 2 shows the non-return flap 8 in its opened position, in which the non-return flap 8 opens the flow-through opening 9a. FIG. 3 shows the non-return flap 8 in its closed position, in which the non-return flap 8 closes the flow-through opening 9a and, in particular, makes contact in the area of its lower edge in the process with a limit stop 11 on the inner wall of the pipe element 9. As is evident from FIG. 3, the non-return flap 8 is tilted somewhat towards the vertical in its closed position, so the non-return flap 8 is pressed against the limit stop 11 by its own weight.

The dust is fed into the separator 4 via the air flow from the collection point 2 during the operation of the system 1. The non-return flap 8 is automatically opened by the pressure forces exerted by the air flow, designated as F₁ in FIG. 2, so the air flow containing the dust is fed into the separator 4.

If an explosion occurs in the separator 4, a high explosion pressure arises because of the explosion. The pressure forces caused by that, designated as F₂ in FIG. 3, are considerably greater than the forces F₁ and are opposed to them, so they press the non-return flap 8 against the limit stop 11, close the flow-through opening 9a and therefore prevent a spread of the explosion in the direction of the collection point 2. Because of the adherence of the mounting distance d of the non-return flap 8 to the separator 4, it is ensured that the non-return flap 8 can be promptly and completely closed by the explosion pressure when an explosion occurs.

When an explosion occurs, the danger exists, especially when several explosion shock waves arise, that the non-return flap 8 will swing back from the limit stop 11 and thereby open the flow-through opening 9a, eliminating the explosion decoupling.

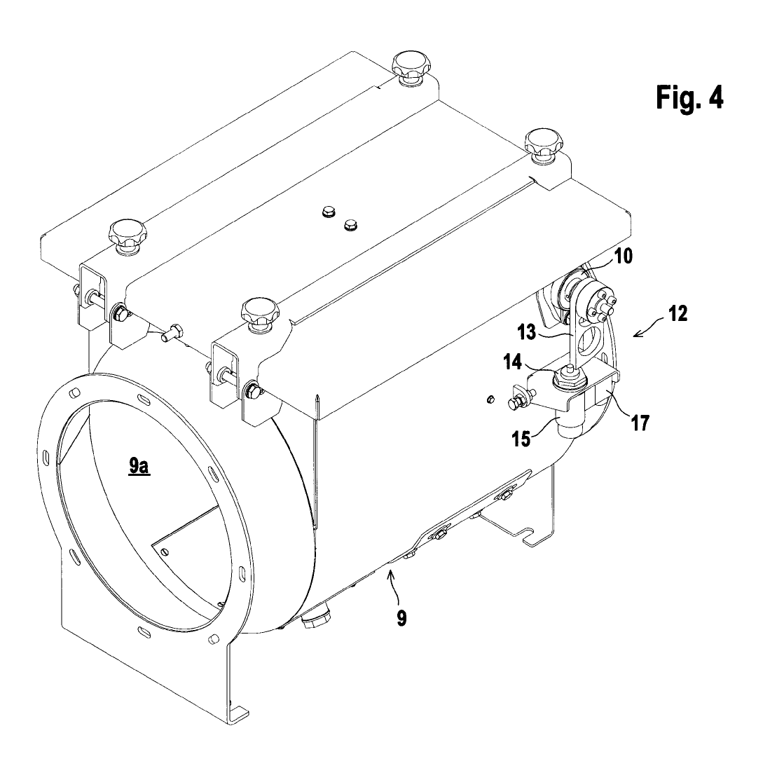

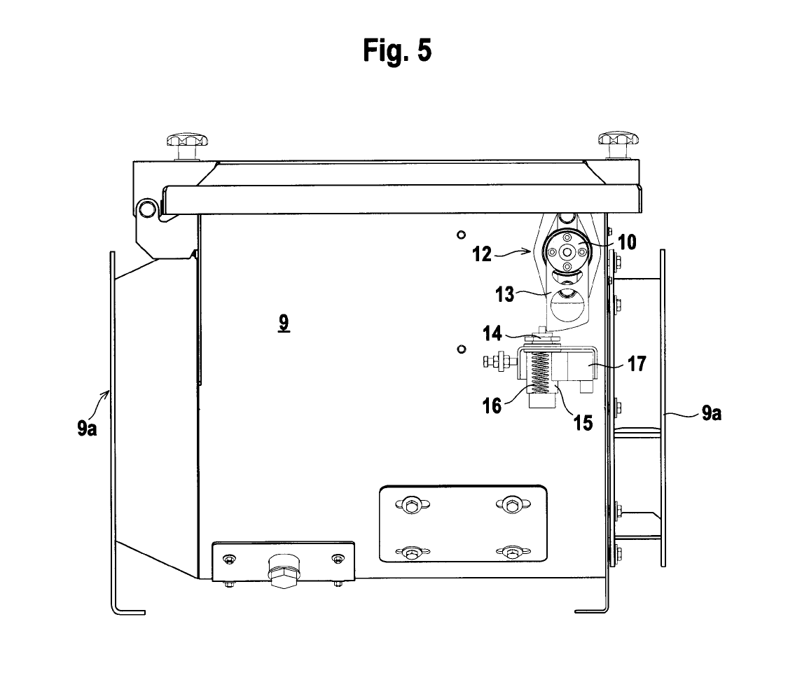

A locking device 12 whose components are shown in FIGS. 4 and 5 is provided on the outside of the pipe element 9 to rule out a potential danger of that type. The components of the locking device 12 are preferably arranged in a protected fashion in a housing that is not shown on the outside of the pipe element 9.

A locking element 13 in the form of a cam is provided as the first component of the locking device 12. The lower edge of the cam has an arched and curved contour. The locking element 13 is fastened to an end of the shaft 10 brought out through the pipe element 9 to which the non-return flap 8 is mounted in a swiveling fashion. The locking element 13 is rigidly connected to the end of the shaft here.

A locking bolt 14 whose longitudinal axis runs in the vertical direction and that is mounted in a housing part 15 is provided as a further component of the locking device 12. The locking bolt 14 is pressed into a locked position by an upwards acting restoring force that is exerted by a spring 16. This locked position of the locking bolt 14 is shown in FIG. 1. The locking bolt 14 projects over the top of the housing part 15 in this locked position. Furthermore, an actuation element 17 is provided by means of which the locking bolt 14 can be moved against the restoring force of the spring 16 into an end position in which the locking bolt 14 has been moved into the housing part 15. The actuation element 17 has an electromagnet in the present case. Alternatively, a hydraulic or pneumatic actuation element 17 can also be provided.

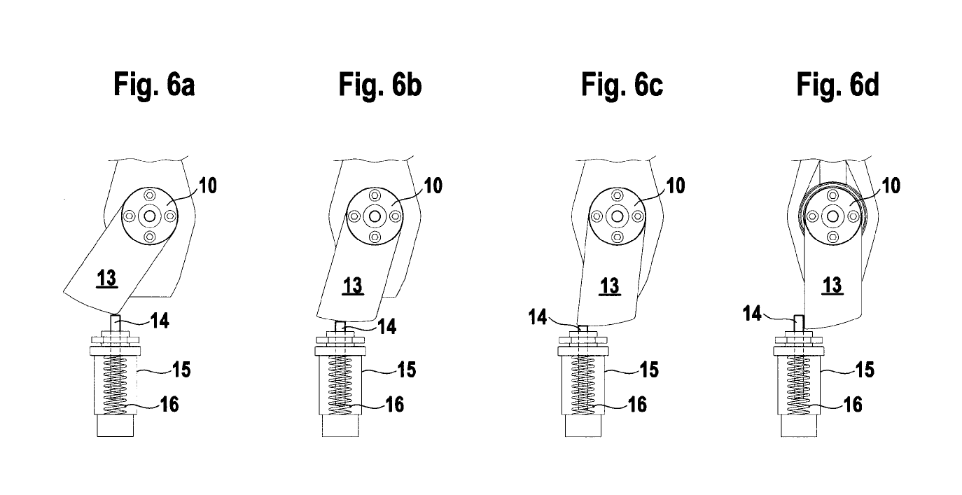

The manner of operation of the locking device 12 is shown in FIGS. 6a) to 6d). The non-return flap 8 is moved against the limit stop 11 when an explosion occurs. The rotary movement of the shaft 10 that takes place in the process is transferred to the cam that constitutes the locking element 13. Because of the arched, asymmetrical curvature of the lower edge of the cam, this lower edge presses the locking bolt 14 downwards against the restoring force when the cam moves over the locking bolt 14 (FIGS. 6a) to 6c)). The geometries and positions of the locking bolt 14 and the cam are adapted in such a way that when the non-return flap 8 makes contact with the limit stop 11, meaning when the non-return flap 8 has reached its closed position, the cam has just passed the locking bolt 14 (FIG. 6d)). The locking bolt 14 then shoots upwards because of the restoring force of the spring 16 and is blocked on the rear edge of the cam, meaning that the cam forms a limit stop 11 that holds the cam in place because of an asymmetric curvature on the lower edge of the locking bolt 14. But the non-return flap 8 is therefore firmly kept in its closed position, meaning a backswing of the non-return flap 8 from the limit stop 11 is no longer possible because a movement of that type will be blocked by the locking bolt 14.

A lasting, tight closure of the flow-through opening 9a of the pipe element 9 is thereby ensured by the non-return flap 8 in the case of an explosion and therefore reliable explosion decoupling of the two system parts.

After an explosion occurs, the locking device 12 can be automatically unlocked with the actuation element 17 by moving the locking bolt 14 against the restoring force of the spring 16 to the end position by means of the actuation element 17. The locking element 13 is therefore released, and the non-return flap 8 can be released from the closed position.

### LIST OF REFERENCE NUMERALS

(1) System

(2) Collection point

(3) Pipeline

(4) Separator

(5) Outlet line

(6) Fan

(7) Explosion pressure relief unit

(8) Non-return flap

(9) Pipe element

(9a) Flow-through opening

(10) Shaft

(11) Limit stop

(12) Locking device

(13) Locking element

(14) Locking bolt

(15) Housing part

(16) Spring

(17) Actuation element

1. Device for explosion decoupling of two system parts, wherein dust capable of explosion can be fed from a first system part through a pipeline (3) in an air flow into a container of a second system part and wherein a non-return flap (8) that is opened by the air flow and closed when there is an explosion in the container because of the explosion pressure that arises is provided in a pipe element (9) integrated into the pipeline (3), wherein the non-return flap (8) makes contact in its closed position with a limit stop (11) in the pipe element (9), characterized in that a locking device (12) is provided on the outside of the pipe element (9) by means of which the non-return valve (8) is secured in the closed position.

2. Device according to claim 1, characterized in that the locking device (12) has a locking element (13) coupled with the non-return flap (8) that is held in place by a locking bolt (14) in the locked position when the non-return flap (8) is in the closed position.

3. Device according to claim 2, characterized in that the non-return flap (8) is mounted in a swiveling fashion on a shaft (10), wherein the end of the shaft (10) is brought out of the pipe element (9) and wherein the locking element (13) is fastened to the end of the shaft.

4. Device according to claim 2, characterized in that the locking bolt (14) is held in the locked position with a restoring force, bringing about the fixation in place of the locking element (13) when the non-return flap (8) is in the closed position.

5. Device according to claim 4, characterized in that the restoring force is generated by a spring (16).

6. Device according to claim 2, characterized in that the locking element (13) constitutes a cam.

7. Device according to claim 6, characterized in that the contour of the cam is designed in such a way that the locking bolt (14) is moved out of the locked position against the restoring force by the cam when the non-return flap (8) is moved in the direction of the closed position as a result of the explosion pressure arising in the container as a result of an explosion, so the cam is moved over the locking bolt (14) into an end position and the locking bolt (14) is moved into the locked position again after the cam passes over it because of the restoring force and said locking bolt then blocks the cam against being released from the end position.

8. Device according to claim 4, characterized in that an actuation element (17) is provided that is designed to move the locking bolt (14) from the locked position into an unlocked position against the restoring force, wherein the locking bolt (14) releases the locking element (13) in the unlocked position so that said locking bolt can be moved out of the end position.

9. Device according to claim 8, characterized in that the actuation element (17) has an electromagnet.

10. Device according to claim 8, characterized in that a hydraulic or pneumatic actuation element (17) is provided.
